(19) United States
(12) Patent Application Publication
(10) Pub. No.: US 2019/0078402 A1
(43) Pub. Date: Mar. 14, 2019

(54) SYSTEMS AND METHODS FOR DETERMINING CONNECTION INTEGRITY BETWEEN TUBULARS

(71) Applicant: Frank's International, LLC, Houston, TX (US)

(72) Inventors: Brennan Domec, Sunset, LA (US); Eric Nall, Lafayette, LA (US); Joshua Hebert, Breaux Bridge, LA (US); Joshua Renard, Erath, LA (US)

(21) Appl. No.: 16/125,324

(22) Filed: Sep. 7, 2018

Related U.S. Application Data
(60) Provisional application No. 62/556,207, filed on Sep. 8, 2017.

(51) Int. Cl. E21B 19/16; E21B 17/042; E21B 47/00; G01L 1/24

(52) U.S. Cl. CPC E21B 19/166; G01L 1/241; E21B 47/0006; E21B 17/042

(57) ABSTRACT

A method for determining an integrity of a connection includes applying a high-contrast material to a connection between a first tubular and a second tubular. A torque is applied to the first tubular. Applying the torque to the first tubular includes rotating the first tubular relative to the second tubular to establish the connection. A change in pattern of the high-contrast material in analyzed, while the torque is applied to the first tubular, using a strain detection tool that does not contact the connection. A strain at the connection is determined, based at least partially upon analyzing the change in pattern of the high-contrast material. An integrity of the connection is determined, based at least partially upon the strain.

### CROSS-REFERENCE TO RELATED APPLICATIONS

This application claims priority to U.S. Provisional Patent Application No. 62/556,207, filed on Sep. 8, 2017, the entirety of which is incorporated by reference.

### BACKGROUND

In the oil and gas industry, tongs are typically used to grip tubular members for connecting and disconnecting two tubular members. More particularly, a first type of tong (i.e., a power tong) rotates a first threaded tubular member, while a second type of tong (i.e., a backup tong) secures a second threaded tubular member against rotation. Individual tubular segments (members) are joined together via threaded connections to form a contiguous string of casing or completion tubing, which is lowered into the wellbore. A single wellbore can have tubular members of varying diameters deployed therein. In larger-diameter tubular members, the torque required to achieve satisfactory makeup of a threaded connection is greater than in smaller-diameter tubular members. Proper makeup of the threaded connection is essential to achieve the connection's rated capacity in tension, external pressure resistance, internal pressure resistance, etc. The tubular string serves as a barrier to isolate the external formation surrounding the wellbore from the interior of the wellbore. Properly made-up threaded connections are key components of this barrier. Achieving a suitable barrier for the well conditions present in the well is typically referred to as achieving well integrity.

A torque-only computer system/method may be used to monitor and graphically display the read-out of a load cell attached to the joint or power tong. The torque-only method has limitations because it does not provide enough information to distinguish quality control problems such as out-of-tolerance threads, cross-threading, or galling.

A torque-turn is a conventional method which is widely used for evaluating the fastening state of a threaded connector and is a “method for monitoring change of a torque to be generated when fastening a threaded joint.” This method is known in the industry as Torque-Turn. “Torque Turn” requires sophisticated electronics including a computer and sensors to monitor both the torque and turns which add to operational costs and delay the running time of the pipe sections. The “Torque Turn” method is extremely sensitive to a reference torque which is a relatively low value, typically 10 percent of the minimum torque. This torque is sometimes determined by API torque recommendations. After this reference torque is reached, a predetermined number of turns are counted in the make-up of the tubular connection. If a false reference torque occurs to activate the turn counter because of quality control problems or assembly conditions, an improper joint make-up will result.

A torque-turn computer system/method may be used to monitor and graphically display the torque applied to the make-up of a first tubular member to a second tubular member as well as the rotations of the first tubular member into the second tubular member during connection (i.e., make-up) and disconnection (i.e., break-out). Connection manufacturers have established specific criteria related to the make-up of threaded connections, which can be monitored via a torque-turn system. The torque-turn system provides an indirect implicit monitoring of the make-up process. The indirect measurements are taken at the power tong, not at the connection itself, and the measurements at the power tong are indirect indicators of the strain of the connection. The torque-turn computer system, while successfully implemented may, however, have certain limitations in indicating connection integrity.

Certain defects present on the threaded elements may cause a sudden rise in the makeup torque during makeup of the elements. Conventional methods suffer from the disadvantage that such a rise in the torque may be erroneously interpreted as corresponding to the makeup state for compression of the abutments, whereas in reality, the connection is still in its first makeup state and is not sealed. In the same manner, in contrast, some defects may also cause a variation in the profile of the torque, which cannot be interpreted or is difficult to interpret, and the connection, albeit made up properly, may be rejected. As a consequence, this presents problems in regard safety and productivity on oil platforms. Further, the threads of the two tubulars may be misaligned or damaged during make-up. As the two tubulars are tightened with respect to one another, the torque-turn computer system may determine that the torque has reached a predetermined level that is associated with proper make-up. However, when the threads are misaligned or damaged, the connection make-up/structural integrity is compromised, which could lead to failure of the connection after subsequent loading or flowing of fluids through the connection.

Another disadvantage is that this method measures torque from the make-up device itself (i.e. power tong) and not at the connector directly. This introduces more variables for potential error to manifest in the torque turn graph. The load-cell also must be properly calibrated in order to determine an accurate torque reading. Slippage of tong gripping jaws may affect the graph. Also, improper doping may cause false torque readings that may be misinterpreted as acceptable torque graphs, but in reality, the connection is in an unacceptable state. Because of its disadvantages, a more reliable method is needed to determine that all features of the threaded connection are properly engaged (i.e. threads, seal, shoulder).

A torque-time computer system/method is where the torque imposed on the premium thread connections between tubular joints is monitored and plotted as a function of time rather than the number of turns. In this manner, the torque at which shoulder by metal-to-metal sealing contact is achieved during make-up of the connection can be detected. Further, torque response of the connection after shouldering may be monitored.

Neither the torque-only, torque-turn, nor the torque-time systems/methods address the issue of allowing the operator to determine the amount of pin member axial engagement or positioning into the box member upon make-up of the joint. This may be used to determine the amount of radial thread interference and whether the ends of the members have undesirably butted together, thereby restricting the bore of the pipe sections or whether there is sufficient thread engagement to withstand subsequent pressure and tensile loading.

### SUMMARY

A method for determining an integrity of a connection is disclosed. The method includes applying a high-contrast material to a connection between a first tubular and a second tubular. The method also includes applying a torque to the first tubular. Applying the torque to the first tubular comprises rotating the first tubular relative to the second tubular to establish the connection. The method also includes analyzing a change in pattern of the high-contrast material, while the torque is applied to the first tubular, using a strain detection tool. The strain detection tool does not contact the connection. The method also includes detecting a strain at the connection, based at least partially upon analyzing the change in pattern of the high-contrast material. The method also includes determining an integrity of the connection, based at least partially upon the strain.

A system for determining an integrity of a connection is also disclosed. The system includes a first tong configured to grip and rotate a first tubular. The system also includes a second tong configured to grip a second tubular. Rotating the first tubular with respect to the second tubular establishes a connection between the first and second tubulars. The system also includes a high-contrast material on the connection. The system also includes a strain detection tool configured to detect a strain in the connection by analyzing a change in pattern of the high-contrast material as the first tubular is rotated. The strain detection tool does not contact the connection. The strain is used to determine an integrity of the connection.

A method for determining an integrity of a first tubular, a second tubular, or a connection therebetween is also disclosed. The method includes applying a high-contrast material to a first tubular, a second tubular, or a connection therebetween. The method also includes varying an axial load on the first tubular, the second tubular, or the connection. The method also includes analyzing a change in pattern of the high-contrast material, as the axial load is varied, using a strain detection tool. The strain detection tool does not contact the first tubular, second tubular, or the connection. The method also includes detecting a strain at the first tubular, the second tubular, or the connection, based at least partially upon analyzing the change in pattern of the high-contrast material. The method also includes determining an integrity of the first tubular, the second tubular, or the connection, based at least partially upon the strain.

A system for determining an integrity of a first tubular, a second tubular, or a connection therebetween is also disclosed. The system includes an elevator configured to lift a string of tubulars, including a first tubular, a second tubular, and a connection therebetween. The system also includes a high-contrast material applied to the first tubular, the second tubular, the connection, or a combination thereof. The system also includes a strain detection tool configured to detect a strain in the first tubular, the second tubular, or the connection, by analyzing a change in pattern of the high-contrast material as an axial load is varied by the elevator lifting the string of tubulars. The strain detection tool does not contact the connection. The strain is used to determine an integrity of the first tubular, the second tubular, or the connection.

A method for determining an integrity of a connection is also disclosed. The method includes introducing an input signal to a connection between a first tubular and a second tubular. The method also includes applying a torque to the first tubular by rotating the first tubular. The method also includes receiving an output signal from the connection. The rotation of the first tubular causes the input signal to be modified to produce the output signal. The method also includes comparing the input signal to the output signal. The method also includes determining an integrity of the connection, in response to the rotation, based at least partially upon the comparison of the input signal to the output signal.

A system for determining an integrity of a connection is also disclosed. The system includes a first tong configured to grip and rotate a first tubular. The system also includes a second tong configured to grip a second tubular. The system also includes a signal generator configured to introduce an input signal into a connection between the first and second tubulars. The system also includes a signal receiver configured to receive an output signal from the connection. The rotation of the first tubular causes the input signal to be modified to produce the output signal.

A method for determining an integrity of a first tubular, a second tubular, or a connection therebetween is also disclosed. The method includes introducing an input signal into a first tubular, a second tubular, or a connection therebetween, using a signal generator. The method also includes varying an axial load on the first tubular, the second tubular, or the connection. The method also includes receiving an output signal from the first tubular, the second tubular, or the connection using a signal receiver, while the axial load is varied. Varying the axial load causes the input signal to be modified to produce the output signal. The method also includes comparing the input signal to the output signal using a signal processor. The method also includes determining an integrity of the first tubular, the second tubular, or the connection, in response to varying the axial load, based at least partially upon the comparison of the input signal to the output signal.

A system for determining an integrity of a first tubular, a second tubular, or a connection therebetween is also disclosed. The system includes an elevator configured to lift a string of tubulars, including a first tubular, a second tubular, and a connection therebetween. The system also includes a signal generator configured to introduce an input signal into the first tubular, the second tubular, or the connection. The system also includes a signal receiver configured to receive an output signal from the first tubular, the second tubular, or the connection. A change in an axial load experienced at the first tubular, the second tubular, or the connection causes the input signal to be modified to produce the output signal.

The foregoing summary is intended merely to introduce a subset of the features more fully described of the following detailed description. Accordingly, this summary should not be considered limiting.

### BRIEF DESCRIPTION OF THE DRAWINGS

The accompanying drawing, which is incorporated in and constitutes a part of this specification, illustrates an embodiment of the present teachings and together with the description, serves to explain the principles of the present teachings. In the figures:

FIG. 1 depicts a side view of a system for making up and determining an integrity of a threaded connection, according to an embodiment.

FIG. 2 depicts a cross-sectional view of the system through line 2-2 in FIG. 1, according to an embodiment.

FIGS. 3A and 3B depict a flowchart of a method for determining the integrity of a threaded connection (e.g., using the system shown in FIG. 1), according to an embodiment.

FIG. 4A illustrates a cross-sectional view of a threaded connection between first and second tubulars when the first and second tubulars have a standard interference thread-type connection, according to an embodiment.

FIG. 4B illustrates an image of the stress state on the outer surfaces of the first and second tubulars shown in FIG. 4A when the make-up state (i.e., integrity) of the connection is less than a predetermined threshold (i.e., acceptable), according to an embodiment.

FIG. 4C illustrates an image of the stress state on the outer surfaces of the first and second tubulars shown in FIG. 4A when the make-up state (i.e., integrity) of the connection is greater than the predetermined threshold (i.e., unacceptable), according to an embodiment.

FIG. 5A illustrates a cross-sectional view of the connection between the first and second tubulars when the first and second tubulars have a standard threaded-type connection and the connection is greater than the predetermined threshold (i.e., unacceptable), and FIG. 5B illustrates an enlarged view of a portion of FIG. 5A, according to an embodiment. More particularly, FIG. 5B illustrates mis-matched pin threads (i.e., missing a corner radius on a stab flank of a thread), which causes unintended interference with the box thread and consequently increases the torque required to make-up the pin connection into the box connection.

FIG. 6A illustrates a cross-sectional view of the connection between the first and second tubulars when the first and second tubulars have a metal-to-metal seal-type threaded connection, according to an embodiment.

FIG. 6B illustrates an image of the stress state on the outer surfaces of the first and second tubulars shown in FIG. 6A, according to an embodiment.

FIG. 7A illustrates another cross-sectional view of the connection between the first and second tubulars when the first and second tubulars have a standard threaded-type connection, according to an embodiment. More particularly, the connection is shown as a mis-stabbed connection with the pin thread crests lined up with the box thread crests rather than with the box thread roots.

FIG. 7B illustrates an image of the stress on the outer surfaces of the first and second tubulars shown in FIG. 7A, according to an embodiment. More particularly, the connection shown is not made-up properly, and the stress state is attributable to the connection mis-stab rather than achieving proper make-up of the pin connection into the box connection.

FIG. 8 illustrates a side view of another system for determining an integrity of a connection, according to an embodiment.

FIG. 9 illustrates a flowchart of another method for determining an integrity of a connection (e.g., using the system shown in FIG. 8), according to an embodiment.

FIG. 10 illustrates a computing system for performing at least a portion of one of the methods disclosed herein, according to an embodiment.

It should be noted that some details of the figure have been simplified and are drawn to facilitate understanding of the embodiments rather than to maintain strict structural accuracy, detail, and scale.

### DETAILED DESCRIPTION

Reference will now be made in detail to embodiments of the present teachings, examples of which are illustrated in the accompanying drawing. In the drawings, like reference numerals have been used throughout to designate identical elements, where convenient. The following description is merely a representative example of such teachings.

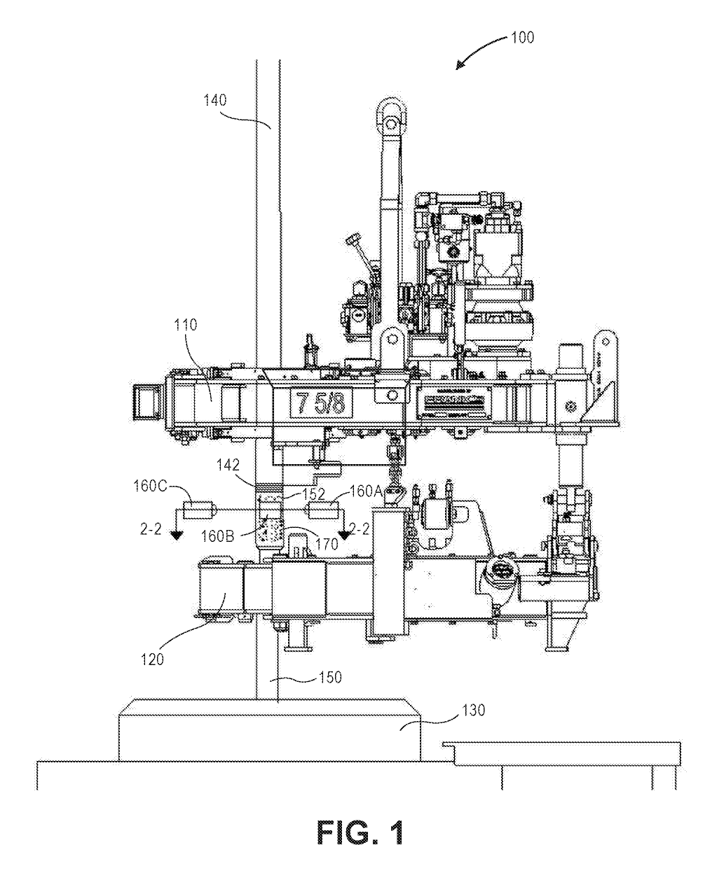

FIG. 1 illustrates a side view of a system 100 for determining an integrity of a connection, according to an embodiment. The system 100 may include one or more tongs (two are shown: 110, 120), a tubular supporting apparatus (e.g., a spider) 130, and one or more measurement tools (three are visible: 160A-C). A first (e.g., upper) tubular 140 may be gripped by the first tong 110, and a second (e.g., lower) tubular 150 may be gripped by the second tong 120 and/or the spider 130. FIG. 1 depicts an example of what is generally described as an integral joint connection, where the box connection as well as the pin connection are threaded directly onto the tubular segments. Another connection type may include a pin connection threaded onto each joint, and the joints are then connected with female threaded couplings. The methods described herein are applicable to both types of connections. The spider 130 may support at least a portion of the weight of the first and/or second tubulars 140, 150 before, during, and/or after the tongs 110, 120 connect or disconnect the first and second tubulars 140, 150.

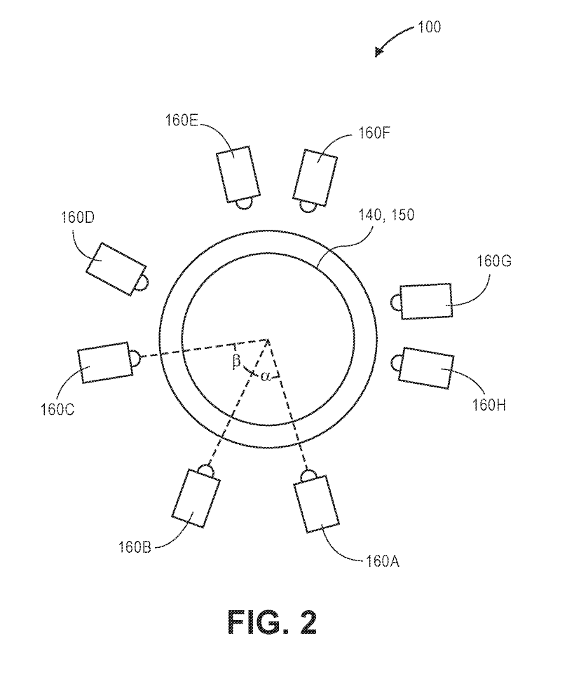

A lower end 142 of the first tubular 140 and an upper end 152 of the second tubular 150 may be positioned axially between the two tongs 110, 120. As described in greater detail below, the lower end 142 of the first tubular 140 may be placed in contact with the upper end 152 of the second tubular 150 to connect the first and second tubulars 140, 150. The measurement tools 160A-H (see FIGS. 1 and 2) may be axially-aligned with the intersection of the first and second tubulars 140, 150 and positioned radially-outward therefrom. In another embodiment, the measurement tools 160A-H may be axially-offset from the intersection. In at least some embodiments, the measurement tools 160A-H may not physically contact the tubulars 140, 150.

The measurement tools 160A-C may be configured to measure a parameter (e.g., strain) related to the first tubular 140, the second tubular 150, or the connection therebetween. In one example, the strain being measured is the strain (i.e., elastic expansion) of the female (i.e. box) connection due to makeup of the male threaded connection into the box connection. The elastic expansion is attributable to the fact that the threaded connections are conical in nature, and the makeup of the conical pin into the conical box results in expansion of the box (i.e., female threaded component). In addition, metal-to-metal sealing features, in some connections, are typically conical in nature as well and require high contact force between the mating surfaces of the pin and box connections. The high contact force at the conical metal sealing surface results in localized expansion of the box connection. Axial strain may also be generated by the power-screw effect of the threads engaging as torque is applied. Hoop and radial strain can be generated by the thread design (if not a square thread). Shear strain can also be detected as a result of galling, etc. Further, strains may also be detected in the pin, adjacent to the pin, and/or adjacent to the box. Strains can also be detected in the tubular body.

The measurement of the strain may be representative of, and thus enable a determination of, the local strain and/or stress on the first and/or second tubulars 140, 150 or the connection, during make-up or break-out. From this information, the system 100 may be configured to make a determination of the make-up state (i.e., integrity) of the connection that is made between the tubulars 140, 150. For example, as will be described in greater detail below, a high-contrast material 170 may be applied or otherwise provided on the first and/or second tubulars 140, 150 (e.g., proximate to the connection therebetween). When the first and second tubulars 140, 150 are joined by a threaded coupling, the high-contrast material 170 may also or instead be applied or otherwise provided on the exterior of the coupling. The measurement tools 160A-H may be configured to detect the strain, or allow for a detection of the strain (e.g., by measuring deformation of the tubulars 140, 150 and/or the coupling through analyzing the change in pattern of the high-contrast material 170).

FIG. 2 depicts a cross-sectional view of the system 100 through line 2-2 in FIG. 1, according to an embodiment. Five additional measurement tools 160D-H are shown. The measurement tools 160A-H may be circumferentially-offset from one another around the first tubular 140, the second tubular 150, or the intersection therebetween. The measurement tools 160A-H may be positioned in pairs (e.g., 160A and 160B; 160C and 160D; 160E and 160F; 160G and 160H). The first pair 160A, 160B may view a first common, overlapping area on the first tubular 140, the second tubular 150, or both, the second pair 160C, 160 D may view a second common, overlapping area on the first tubular 140, the second tubular 150, or both, and so on. The first and second common, overlapping areas may be different.

The common view area, at the different angles, may enable the measurement tools (e.g., 160A, 160B) in a single pair to capture three-dimensional measurements, and the plurality of pairs may be able to capture a plurality of three-dimensional measurements around the circumference of the first tubular 140, the second tubular 150, or both. Although not shown, in another embodiment, a single measurement tool may be used to capture two-dimensional measurements. An angle α between the measurement tools (e.g., 160A, 160B) in a single pair may be less than an angle β between two adjacent pairs. For example, the angle α may be from about 5° to about 45°, about 5° to about 30°, or about 5° to about 20°, and the angle β may be from about 30° to about 90°, about 45° to about 90°, or about 60° to about 90°.

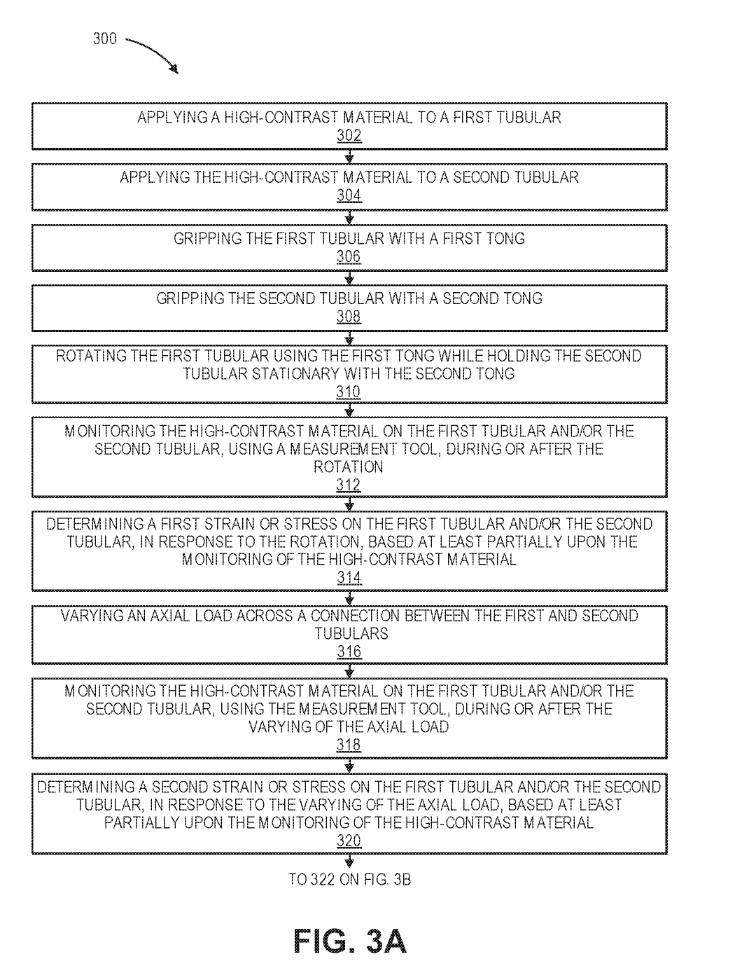

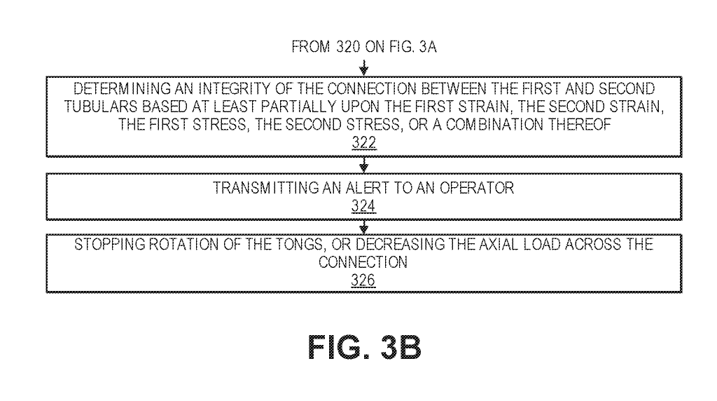

FIGS. 3A and 3B illustrate a flowchart of a method 300 for determining an integrity of a connection, according to an embodiment. The method 300 may implement torque-turn technology, digital image correlation (DIC) technology, or a combination thereof to determine the integrity of the connection. Torque-turn technology uses sensors mounted to the power tong 110 and a computing system 800 (see below) to monitor both torque and turns applied to the connection between the tubulars 140, 150. The torque-turn technology may be sensitive to a reference torque (e.g., 10% of the minimum torque). After the reference torque is reached, a predetermined number of turns are counted in the make-up of the tubular connection. If a false reference torque occurs to activate the turn-counter, an improper make-up may occur. The criteria for acceptable make-up of threaded connections may include minimum torque, optimum torque, delta torque after shoulder, and delta turns after shoulder. Connection make-up is deemed acceptable or not based on adherence to criteria established by the connection manufacturer.

DIC technology is an optical method to measure deformation of an object's surface without touching the object's surface (e.g., using measurement tools 160A-H). DIC technology may be used directly to monitor and evaluate the state of or changes in the state of surface strain of the threaded connection in real-time during field makeup to determine that the make-up state and therefore the integrity of the connection is within a predetermined limit (e.g., that seals are properly engaged, the shoulder is properly torqued, there is no damage to the threads of the pin or box, and that no other defect is present in the connection).

In some embodiments, the method 300 may include applying the high-contrast material (see reference number 170 in FIG. 1) to at least a portion of an outer surface of the first tubular 140, as at 302. The method 300 may also include applying the high-contrast material 170 to at least a portion of an outer surface of the second tubular 150, as at 304. In some embodiments, the high contrast material 170 may be applied to the outer surface of the connection. In some embodiments, the high-contrast material 170 can be provided on the outer surface of the tubulars 140, 150 using other forming operations. If a threaded coupling is used to join the first and second tubulars 140, 150, the high-contrast material 170 may also or instead be applied on the outer surface of the threaded coupling.

The high-contrast material 170 may be applied to portions of the first and second tubulars 140, 150 (or the coupling) where the parameter (e.g., strain) is to be measured, as discussed below. If the strain is to be measured proximate to the connection between the first and second tubulars 140, 150, the high-contrast material 170 may be applied to the lower portion of the first tubular 140 and the upper portion of the second tubular 150 and/or on the coupling. The lower end 142 of the first tubular 140 may be or include a male (e.g., pin) connection, and the upper end 152 of the second tubular 150 may be or include a female (e.g., box) connection, or vice versa.

The high-contrast material 170 may be any type of material that is configured to be easily-read by the measurement tools 160A-H and thus facilitate taking accurate strain measurements. Thus, when provided, the particular type of high-contrast material 170 may vary depending on the type of measurement tools 160A-H employed. For example, in embodiments in which the measurement tools 160A-H are cameras, the high-contrast material 170 may include a plurality of particles/speckles that are a different color than a base. In a specific example, the high-contrast material 170 may be or include a first layer of a light (e.g., white) base paint and a second layer of a dark (e.g., black) spray paint that is sprayed over the while base paint to form black particles/speckles. In another example, the high-contrast material 170 may be or include a tape with particles/speckles or another pattern thereon. The high-contrast material 170 may be applied by a device that is automated on one or more of the tongs 110, 120, the spider 130, an elevator, or the like.

The method 300 may also include gripping the first tubular 140 with the first tong 110, as at 306. The method 300 may also include gripping the second tubular 150 with the second tong 120, as at 308. The first and second tubulars 140, 150 may be gripped by the first and second tongs 110, 120, respectively, such that the lower end 142 of the first tubular 140 is in contact with, or almost in contact with, the upper end 152 of the second tubular 150.

The method 300 may also include rotating the first tubular 140 using the first tong 110 relative to the second tubular 150, which is held stationary (e.g., by the second tong 120), as at 310. For example, the first tubular 140 may be rotated, and the second tubular 150 may be held stationary, to screw the pin end into the box end to connect (i.e., make-up) the tubulars 140, 150. In another example, the first tubular 140 may be rotated, and the second tubular 150 may be held stationary, to unscrew the pin end from the box end to disconnect (i.e., break-out) the tubulars 140, 150.

The method 300 may also include measuring a parameter (e.g., strain) of the first tubular 140 or the second tubular 150 (or the threaded coupling), using the measurement tool(s) 160A-H, during or after the rotation. In one example, the strain may be or include a deformation of the first tubular 140, the second tubular, and/or the connection. More particularly, measuring the strain may include monitoring the high-contrast material 170 on the first tubular 140 and/or the second tubular 150, using the measurement tool(s) 160A-H, during or after the rotation, as at 312. As the first tubular 140 is rotated with respect to the second tubular 150, the threaded connections may experience contact forces between the (sealing elements of the) pin and box connections. To continue the make-up of the connection, the rotation requires overcoming the contact force between the (sealing elements of the) pin and box, thus an increase in torque applied to the connection is required. The increase in torque results in a corresponding increase in the surface deformation of the tubulars 140, 150. As mentioned above, the measurement tools 160A-H may be or include cameras that capture images or video, which may be used to detect movement or distortion of the high-contrast material 170 (e.g., movement of the speckles), which may be caused by the deformation. More particularly, in an example, the measurement tools 160A-H may detect movement of the particles/speckles with respect to one another or with respect to a stationary point. From these detections, and with known values of the properties/geometry of the tubulars 140, 150, the strain and/or stress can be calculated.

In some embodiments, additional measurement tools such as acoustic signal generators and/or receivers and/or thermal sensors that are capable of providing signatures for comparison are also included. More particularly, the acoustic generators and/or receivers may determine acoustic signatures of the connection, which varies with the degree of make-up, torque, or abnormalities. The thermal sensors measure the integrity of the connection by measuring heat generated, or the lack thereof, as a function of these parameters (e.g., strains).

In at least one embodiment, the measurement tools 160A-H may be configured to rotate together with the first tubular 140 or the second tubular 150 so that the portion of the first tubular 140 or second tubular 150 viewed by each measurement tool 160A-H remains generally constant during the rotation. For example, the measurement tools 160A-H may be coupled to the first tong 110, the second tong 120, the first tubular 140, or the second tubular 150. In at least one embodiment, a fiberscope, a mirror, and/or a prism may be placed proximate to (e.g., around) the connection to enable the measurement tools 160A-H to monitor different or additional portions of the first and/or second tubulars 140, 150.

The method 300 may also include determining a first strain on the first tubular 140 and/or the second tubular 150, in response to the rotation of the first and/or second tubular 140, 150, based at least partially upon the monitoring of the high-contrast material 170, as at 314. More particularly, the measurement tool(s) 160A-H may determine the first strain using digital image correlation (DIC) based upon the relative movement of the particles/speckles in the high-contrast material 170. The high-contrast material 170 may be monitored, and the first strain may be determined, without the measurement tool(s) 160A-H physically contacting the first and second tubulars 140, 150. Instead of, or in addition to, determining the first strain, a first stress experienced by the first tubular 140 and/or the second tubular 150 may be determined based at least partially upon the measurements taken while monitoring of the high-contrast material 170.

As will be appreciated, the torque may gradually increase as the pin connection is advanced into the box connection. The first strain may be a discrete measurement at one point in time while increasing torque, or the first strain may be a continuous series of measurements while increasing torque.

The method 300 may also include varying an axial load across the connection between the first and second tubulars 140, 150, as at 316. The axial load may be varied after the first and second tubulars 140, 150 are rotated (at 310) to make-up the connection between the first and second tubulars 140, 150. The axial load may be varied (e.g., increased) by lifting the string of tubulars, by an elevator which is suspended from the rig's hoisting system. Thus, the first tubular, the second tubular, or the connection may be monitored (1) when making-up or breaking-out the connection or (2) when varying the axial load, but these situations are independent of one another. In addition, the axial load may not be varied with/after each and every-make up/break-out.

The method 300 may also include measuring the parameter (e.g., strain and/or deformation) again, using the measurement tool(s) 160A-H, during or after the varying of the axial load. More particularly, the measuring may include monitoring the high-contrast material 170 on the first tubular 140 and/or the second tubular 150, using the measurement tool(s) 160A-H, during or after the varying of the axial load, as at 318. As the axial load is varied, the tubulars 140, 150 may experience an axially-directed tension force that causes the tubulars 140, 150 to deform slightly. The measurement tools 160A-H may detect movement of (e.g., the particles/speckles in) the high-contrast material 170 in response to the deformation. As mentioned above, the measurement tools 160A-H may detect movement of the particles/speckles with respect to one another or with respect to a stationary point.

The method 300 may also include determining a second strain on the first tubular 140 and/or the second tubular 150, in response to the varying of the axial load, based at least partially upon the monitoring of the high-contrast material 170, as at 320. More particularly, the measurement tool(s) 160A-H may enable a determination of the second strain using DIC based upon the movement of the particles/speckles in the high-contrast material 170. The high-contrast material 170 may be monitored, and the second strain may be determined, without the measurement tool(s) 160A-H physically contacting the first and second tubulars 140, 150. Instead of, or in addition to, determining the second strain, a second stress experienced by the first tubular 140 and/or the second tubular 150 may be determined based at least partially upon the monitoring of the high-contrast material 170.

The method 300 may also include determining an integrity of the connection between the first and second tubulars 140, 150 based at least partially upon the first strain, the first stress, the second strain, the second stress, or a combination thereof, as at 322. For example, the integrity of the connection may be determined by comparing the first strain and/or the second strain to a library of strain measurements. The library of strain measurements may include strain measurements corresponding to connections with proper/aligned threads and misaligned threads. In another example, the integrity of the connection may be determined by comparing the first stress and/or the second stress to a library of stress measurements. The library of stress measurements may include stress measurements corresponding to connections with proper/aligned threads and misaligned threads. Determining the integrity of the connection may also include determining that the connection is not shouldering. In at least one embodiment, determining the integrity of the connection may include generating a score that indicates the integrity of the connection.

The method 300 may also include transmitting an alert to an operator, as at 324. For example, the alert may be transmitted if (e.g., the score of) the first strain, the first stress, the second strain, the second stress, or a combination thereof is outside of a predetermined range, indicating that the integrity of the connection may be compromised (e.g., below a predetermined threshold). This may occur when the threads are misaligned, or the connection is not shouldering, or seals are not properly engaged, or any other defect is present in the connection.

The method 300 may also include automatically stopping rotation of the first tong 110 and/or the second tong 120, or decreasing the load across the connection, as at 326. This may occur in response to (e.g., the score of) the first strain, the first stress, the second strain, the second stress, or a combination thereof being outside the predetermined range. The method may also include automatically stopping rotation of the first tong 110 when makeup requirements have been successfully achieved. Rotation may also stop in response to the integrity of the connection being less than the predetermined threshold. In another embodiment, rather than automatically performing this action, the user may initiate this action in response to the alert. The tongs 110, 120 may then release the tubulars 140, 150, respectively.

Thus, as will be appreciated, the method 300 may provide a full-field image analysis that can determine the contour and displacements of an object (e.g., a tubular) under load in one, two, or three dimensions. The measurements may be obtained in real-time and be used to validate the strength of the objects, without applying strain gauges to the surfaces of the objects. In at least one embodiment, the method 300 may allow a user to visualize the real-time loading of the objects in combination with an augmented reality headset or a digital display. This may allow the user to verify the connection make-up by comparing real-time data to a library. For example, the user may verify a positive shoulder/seal engagement around the circumference, a circumferential seal pressure, a shoulder/interface preload, proper threading, and the like.

The DIC may provide a full field strain/stress map of the outer surface of the tubulars 140, 150 proximate to the connection. The accuracy of the full field strain/stress map may be down to about 50 micro-strain (e.g., about 1450 psi for steel). The connection may be a standard threaded-type connection or a metal-to-metal seal-type connection.

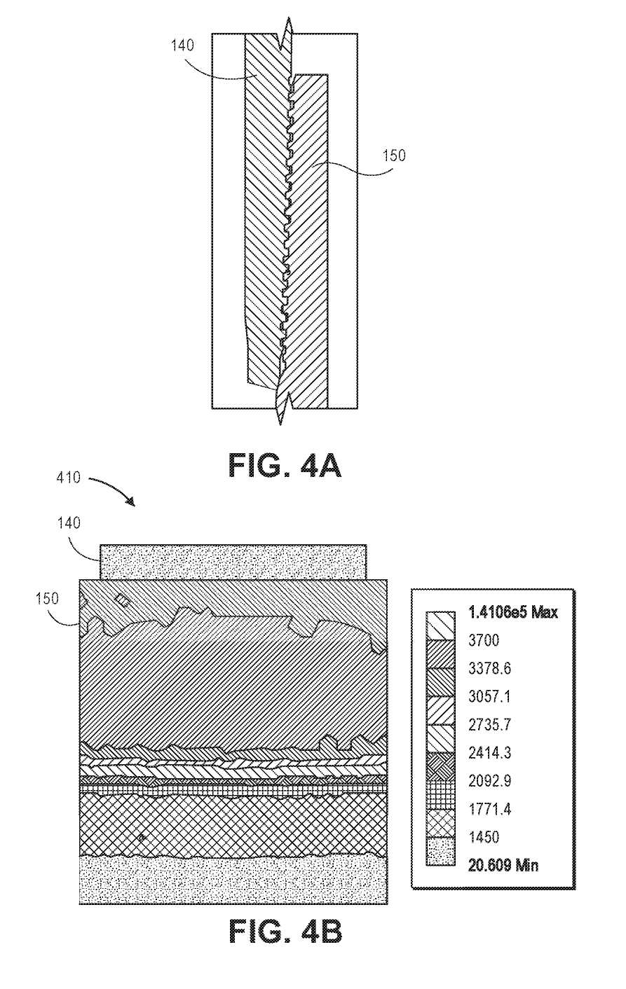

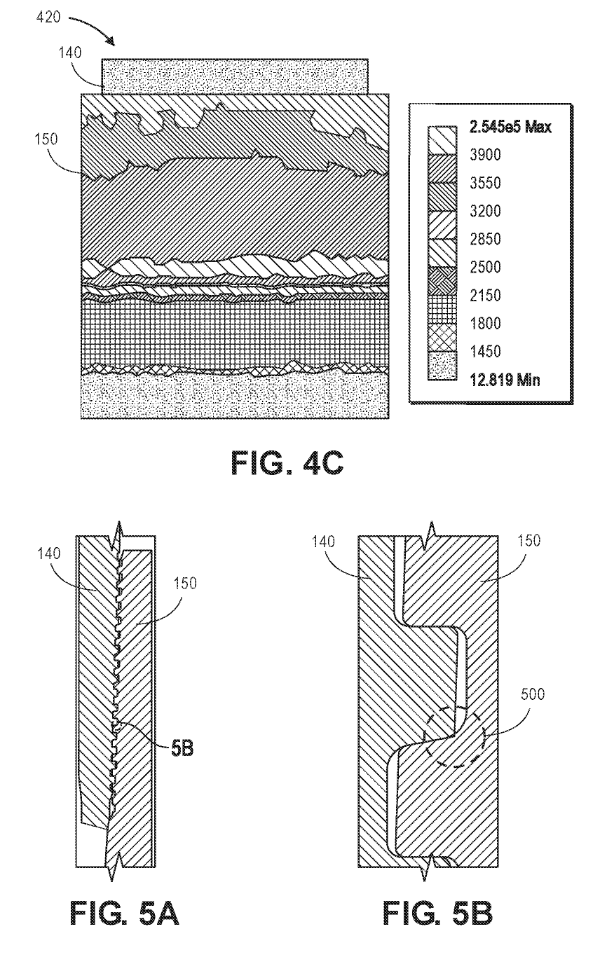

FIG. 4A illustrates a cross-sectional view of the connection between the first and second tubulars 140, 150 when the first and second tubulars 140, 150 have a standard threaded-type connection, according to an embodiment. FIGS. 4B and 4C illustrate images 410, 420 of the stress on the outer surfaces of the first and second tubulars 140, 150 shown in FIG. 4A, according to an embodiment. The units in FIGS. 4B and 4C are pounds per square inch (PSI). The stress map in FIG. 4B is below a predetermined threshold, and thus the integrity of the connection is considered acceptable. The stress map in FIG. 4C is above the predetermined threshold, and thus the integrity of the connection is considered unacceptable.

FIG. 5A illustrates a cross-sectional view of the connection between the first and second tubulars 140, 150 when the first and second tubulars 140, 150 have a standard threaded-type connection, and FIG. 5B illustrates an enlarged view of a portion of FIG. 5A, according to an embodiment. As shown in the circle 500, a defect exists in the threads of the tubulars 140, 150 that may cause the integrity of the connection to be considered unacceptable (e.g., as in FIG. 4C). This defect may not be detected using torque-turn technology alone.

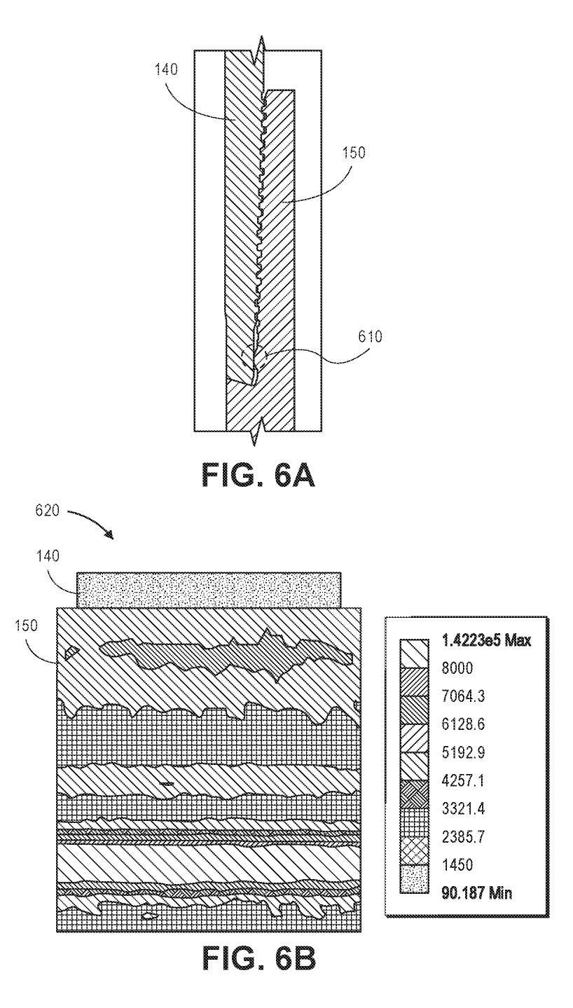

FIG. 6A illustrates a cross-sectional view of the connection between the first and second tubulars 140, 150 when the first and second tubulars 140, 150 have a metal-to-metal seal-type connection 610, according to an embodiment. FIG. 6B illustrates an image 620 of the stress map on the outer surfaces of the first and second tubulars 140, 150 shown in FIG. 6A, according to an embodiment. The units in FIG. 6B are PSI. The stress map in FIG. 6B is below a predetermined threshold, and thus the integrity of the connection is considered acceptable. More particularly, the metal-to-metal seal 610 is engaged properly, thus providing a fluid-tight connection.

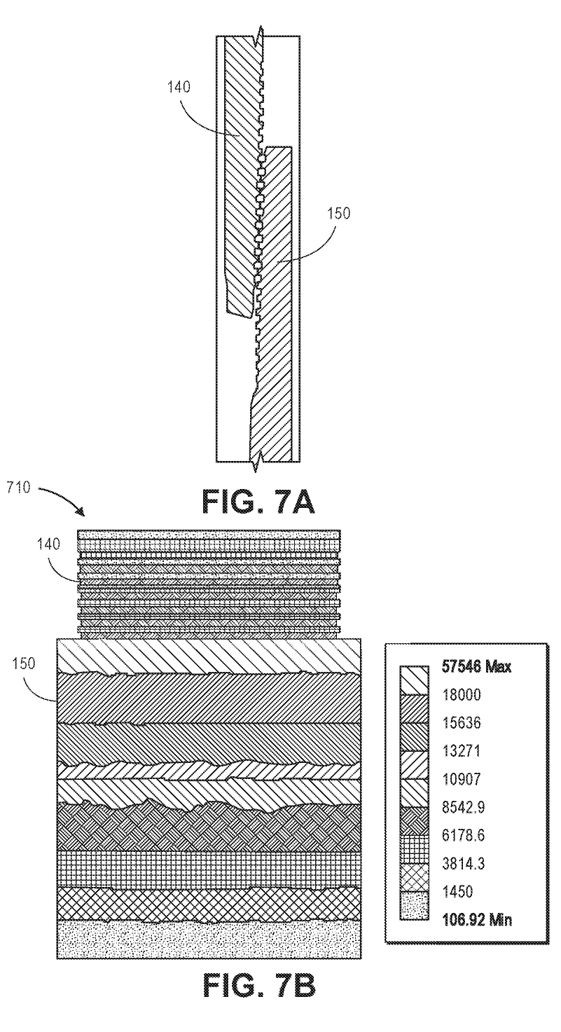

FIG. 7A illustrates another cross-sectional view of the connection between the first and second tubulars 140, 150 when the first and second tubulars 140, 150 have a standard threaded-type connection, according to an embodiment. As shown, the crest-to-crest interference between the male and female threads is indicative of a mis-stab of the pin into the box. FIG. 7B illustrates an image 710 of the stress on the outer surfaces of the first and second tubulars 140, 150 shown in FIG. 7A, according to an embodiment. The units in FIG. 7B are PSI. The stress in FIG. 7B is above a predetermined threshold, and thus the integrity of the connection is considered unacceptable.

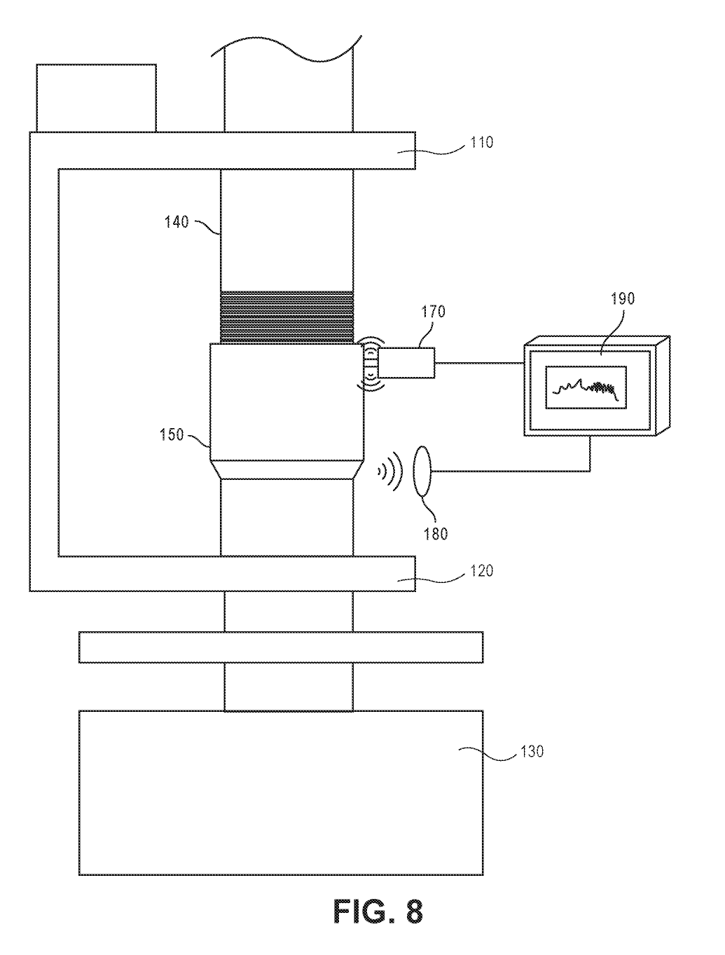

FIG. 8 depicts a side view of a system 800 for determining an integrity of a connection, according to an embodiment. The system 800 may be similar to the system 100 above. For example, the system 800 may include one or more tongs (two are shown: 110, 120) and a tubular supporting apparatus (e.g., a spider) 130. The system 800 may also include one or more measurement tools (three are shown: 170, 180, 190). The measurement tools may be or include a signal generator 170, a signal receiver 180, and a signal processor 190.

The first (e.g., upper) tubular 140 may be gripped by the first tong 110, and the second (e.g., lower) tubular 150 may be gripped by the second tong 120 and/or the spider 130. The spider 130 may support at least a portion of the weight of the first and/or second tubulars 140, 150 before, during, and/or after the tongs 110, 120 connect or disconnect the first and second tubulars 140, 150. A lower end of the first tubular 140 and an upper end of the second tubular 150 may be positioned axially between the two tongs 110, 120. As described in greater detail below, the lower end of the first tubular 140 may be placed in contact with the upper end of the second tubular 150 to connect the first and second tubulars 140, 150.

The signal generator 170 may be in coupled to or otherwise in contact with the first tubular 140, the second tubular 150, and/or the connection. In other embodiments, the signal generator 170 may not be in contact with any of the first tubular 140, the second tubular 150, and/or the connection. The signal generator 170 may be configured to generate a (e.g., acoustic) signal that is introduced into the first tubular 140, the second tubular 150, or the connection. The signal may be a waveform that is continuous and of a known shape (e.g., sinusoidal). In another embodiment, the signal may be or include one or more discrete impulses that is/are introduced into the first tubular 140, the second tubular 150, or the connection.

The signal receiver (also referred to as an acoustic sensor) 180 may be in coupled to or otherwise in contact with the first tubular 140, the second tubular 150, and/or the connection. However, as shown, in another embodiment, the signal receiver 180 may be spaced radially-away from each of the first tubular 140, the second tubular 150, and the connection (e.g., from about 1 cm to about 10 cm). The signal receiver 180 may be configured to receive the signal (i.e., the frequency response) after the signal travels through the first tubular 140, the second tubular 150, and/or the connection therebetween.

As shown, the signal generator 170 may be configured to introduce the signal into, and the signal receiver 180 may be configured to receive the signal from, the same tubular. In another embodiment, the signal generator 170 may be configured to introduce the signal into one of the tubulars (e.g., the first tubular 140), and the signal receiver 180 may be configured to receive the signal from the other tubular (e.g., the second tubular 150). In this embodiment, the signal travels through the connection between the first and second tubulars 140, 150.

The signal processor 190 may be coupled to and in communication with the signal generator 170 and the signal receiver 180. The signal processor 190 may be configured to receive the signal generated by the signal generator 170 (i.e., the signal that is introduced into the first or second tubular 140, 150 or the connection) and to receive the signal received by the signal receiver 180 (e.g., after the signal travels through the first tubular 140, the second tubular 150, or the combination therebetween). The signal processor 190 may then compare the signals from the signal generator 170 and the signal receiver 180, as described below, to determine an integrity of the connection.

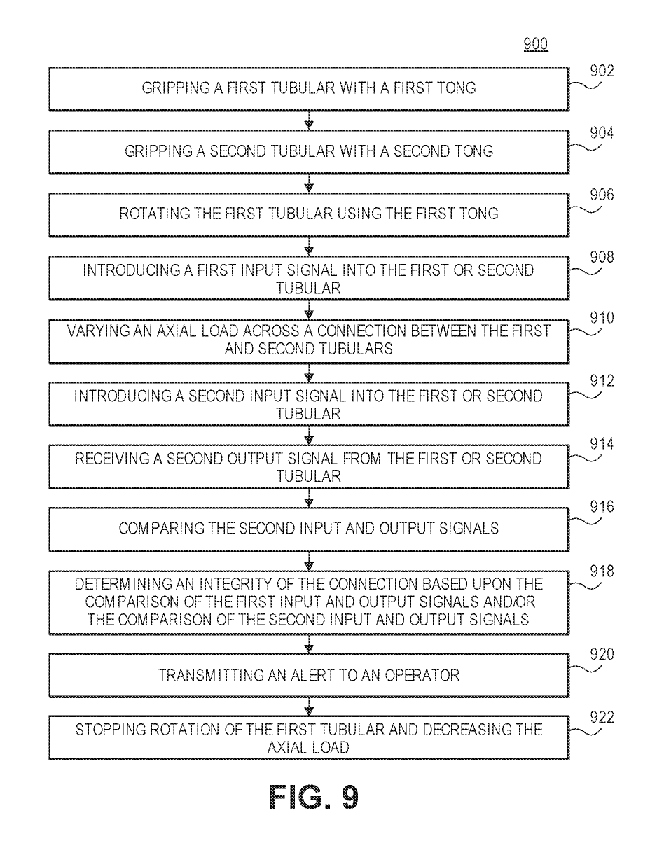

FIG. 9 depicts a flowchart of a method 900 for determining an integrity of a connection (e.g., using the system 800), according to an embodiment. The method 900 may implement acoustic technology to determine the integrity of the connection. Acoustic technology uses a frequency response, which may be independent of amplitude, intensity, or both. Acoustic technology may also be implemented on flush outer diameter (OD) connections.

The method 900 may also include gripping the first tubular 140 with the first tong 110, as at 902. The method 900 may also include gripping the second tubular 150 with the second tong 120, as at 904. The first and second tubulars 140, 150 may be gripped by the first and second tongs 110, 120, respectively, such that the lower end of the first tubular 140 is in contact with, or almost in contact with, the upper end of the second tubular 150.

The method 900 may also include rotating the first tubular 140 using the first tong 110 and/or rotating the second tubular 150 using the second tong 120, as at 906. For example, the first tubular 140 may be rotated, and the second tubular 150 may be held stationary, to screw the pin end into the box end to connect (i.e., make-up) the tubulars 140, 150. In another example, the first tubular 140 may be rotated, and the second tubular 150 may be held stationary, to unscrew the pin end from the box end to disconnect (i.e., break-out) the tubulars 140, 150. In embodiments where both tubulars 140, 150 are rotated, they are rotated in opposing directions. In at least one embodiment, the measurement tools 170, 180, 190 may be configured to rotate together with the first tubular 140 or the second tubular 150. For example, the measurement tools 170, 180, 190 may be coupled to the first tong 110, the second tong 120, the first tubular 140, or the second tubular 150.

As mentioned above, the first input signal may travel through at least a portion of the first tubular 140, the second tubular 150, and/or the connection. As the tubulars 140, 150 are rotated with respect to one another, they may experience forces, including a torsion force (i.e., torque) that may modify the first input signal to produce the first output signal. More particularly, the (e.g., frequency response of the) signal may change or be modified as the stiffness of the connection changes in response to forces (e.g., torsion and/or tensile forces).

The method 900 may also include varying an axial load across the connection between the first and second tubulars 140, 150, as at 910. The axial load may be varied after the first and second tubulars 140, 150 are rotated (at 906) to make-up the connection between the first and second tubulars 140, 150. The axial load may be varied (e.g., increased) by lifting the string of tubulars. Thus, the connection may be monitored (1) when making-up or breaking-out the connection or (2) when varying the axial load, but these situations are independent of one another. In addition, the axial load may not be varied with/after each and every-make up/break-out.

The method 900 may also include introducing a second input signal, which may be an acoustic signal, from the signal generator 170 into the first tubular 140 or the second tubular 150, during or after the varying of the axial load, as at 912. The method 900 may also include receiving a second output signal, which may be an acoustic signal, with the signal receiver 180, as at 914. As mentioned above, the second input signal may travel through at least a portion of the first tubular 140, the second tubular 150, and/or the connection. As the axial load is varied, the tubulars 140, 150 may experience a tensile force that may modify the second input signal to produce the second output signal. The method 900 may also include comparing the second input signal to the second output signal using the signal processor 190, as at 916.

The method 900 may also include determining an integrity of the connection between the first and second tubulars 140, 150, based at least partially upon the comparison of the first input signal and the first output signal and/or the comparison of the second input signal and the second output signal, as at 918. For example, the integrity of the connection may be determined by comparing the first and second output signals, the first input signal and first output signal, and/or the second input signal and second output signal to a library of stored signal data. The library of stored signal data may include signals and/or comparisons of signals corresponding to connections with proper/aligned threads and misaligned threads. Determining the integrity of the connection may also include determining that the connection is not shouldering. In at least one embodiment, determining the integrity of the connection may include generating a score that indicates the integrity of the connection.

The method 900 may also include transmitting an alert to an operator, as at 920. For example, the alert may be transmitted if (e.g., the score of) the integrity of the connection is outside of a predetermined range, indicating that the integrity of the connection may be compromised. This may occur when the threads are misaligned, or the connection is not shouldering.

The method 900 may also include automatically stopping rotation of the first tong 110 and/or the second tong 120, or decreasing the load across the connection, as at 922. This may occur in response to (e.g., the score of) the integrity of the connection being outside the predetermined range. In another embodiment, rather than automatically performing this action, the user may initiate this action in response to the alert. The tongs 110, 120 may then release the tubulars 140, 150, respectively.

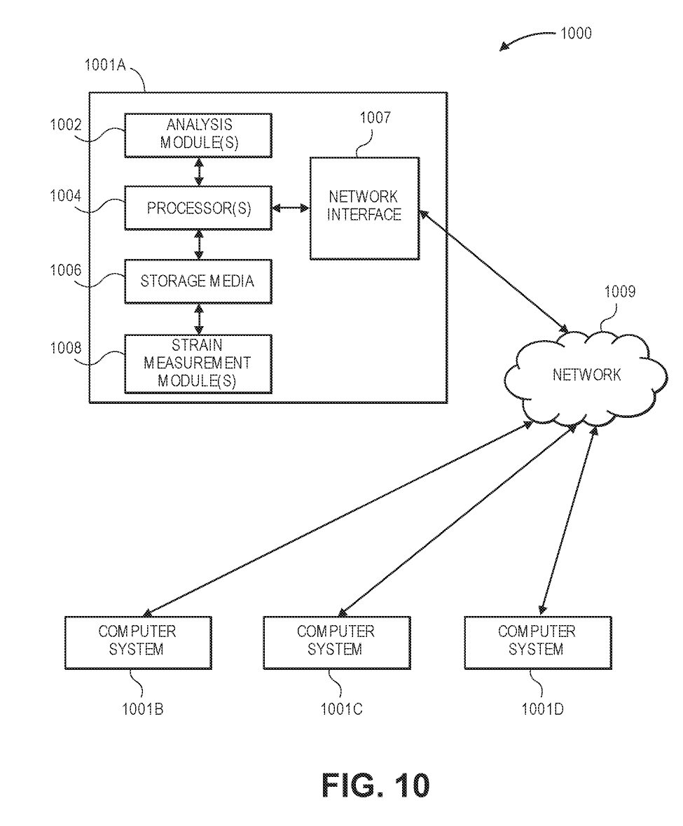

In some embodiments, the methods of the present disclosure may be executed by a computing system. FIG. 10 illustrates an example of such a computing system 1000, in accordance with some embodiments. The computing system 1000 may include a computer or computer system 1001A, which may be an individual computer system 1001A or an arrangement of distributed computer systems. In various embodiments, the computer system 1001A can implement a cloud computing environment. The computer system 1001A includes one or more analysis modules 1002 that are configured to perform various tasks according to some embodiments, such as one or more methods disclosed herein. To perform these various tasks, the analysis module 1002 executes independently, or in coordination with, one or more processors 1004, which is (or are) connected to one or more storage media 1006. The processor(s) 1004 is (or are) also connected to a network interface 1007 to allow the computer system 1001A to communicate over a data network 1009 with one or more additional computer systems and/or computing systems, such as 1001B, 1001C, and/or 1001D (note that computer systems 1001B, 1001C and/or 1001D may or may not share the same architecture as computer system 1001A, and may be located in different physical locations, e.g., computer systems 1001A and 1001B may be located in a processing facility, while in communication with one or more computer systems such as 1001C and/or 1001D that are located in one or more data centers, and/or located in varying countries on different continents). In various embodiments, computing systems 1001B, 1001C, and/or 1001D can represent computing systems utilized by users of the cloud computing environment.

A processor may include a microprocessor, microcontroller, processor module or subsystem, programmable integrated circuit, programmable gate array, or another control or computing device.

The storage media 1006 may be implemented as one or more computer-readable or machine-readable storage media. Note that while in the example embodiment of FIG. 10 storage media 1006 is depicted as within computer system 1001A, in some embodiments, storage media 1006 may be distributed within and/or across multiple internal and/or external enclosures of computing system 1001A and/or additional computing systems. Storage media 1006 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY® disks, or other types of optical storage, or other types of storage devices. Note that instructions may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 1000 contains one or more strain measurement module(s) 1008. In the example of computing system 1000, computer system 1001A includes the strain measurement module 1008. In some embodiments, a single strain measurement module may be used to perform some aspects of one or more embodiments of the methods disclosed herein. In other embodiments, a plurality of strain measurement modules may be used to perform some aspects of methods herein.

It should be appreciated that computing system 1000 is one example of a computing system, and that computing system 1000 may have more or fewer components than shown, may combine additional components not depicted in the example embodiment of FIG. 10, and/or computing system 1000 may have a different configuration or arrangement of the components depicted in FIG. 10. The various components shown in FIG. 10 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included in various embodiments.

As used herein, the terms “inner” and “outer”; “up” and “down”; “upper” and “lower”; “upward” and “downward”; “above” and “below”; “inward” and “outward”; “uphole” and “downhole”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

While the present teachings have been illustrated with respect to one or more implementations, alterations and/or modifications may be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the illustrated embodiment.

Other embodiments of the present teachings will be apparent to those skilled in the art from consideration of the specification and practice of the present teachings disclosed herein. It is intended that the specification and examples be considered as exemplary only, with a true scope and spirit of the present teachings being indicated by the following claims.

What is claimed is:

1. A method for determining an integrity of a connection, comprising:
applying a high-contrast material to a connection between a first tubular and a second tubular;
applying a torque to the first tubular, wherein applying the torque to the first tubular comprises rotating the first tubular relative to the second tubular to establish the connection;
analyzing a change in pattern of the high-contrast material, while the torque is applied to the first tubular, using a strain detection tool, wherein the strain detection tool does not contact the connection;
detecting a strain at the connection, based at least partially upon analyzing the change in pattern of the high-contrast material; and
determining an integrity of the connection, based at least partially upon the strain.

2. The method of claim 1, further comprising determining the integrity of the connection by comparing the strain to a reference strain measurement.

3. The method of claim 2, further comprising automatically stopping rotation of the first tubular when a makeup requirement has been achieved.

4. The method of claim 2, further comprising automatically stopping rotation of the first tubular when the integrity of the connection is less than a predetermined threshold.

5. The method of claim 4, wherein the integrity of the connection is less than the predetermined threshold due to threads of the first and second tubulars being misaligned or damaged, the connection not shouldering, or seals not properly engaging.

6. The method of claim 1, wherein the strain detection tool comprises one or more cameras.

7. The method of claim 6, wherein the strain detection tool comprises a plurality of cameras that are circumferentially-offset from one another around the first tubular, and wherein the plurality of cameras are configured to view a same circumferential area of the first tubular.

8. The method of claim 1, wherein the pattern of the high-contrast material changes due to deformation of an outer surface of the connection.

9. The method of claim 8, further comprising determining a stress on the connection based upon the deformation of the connection, wherein the integrity of the connection is determined based upon the strain, the stress, or both.

10. A system for determining an integrity of a connection, comprising:
a first tong configured to grip and rotate a first tubular;
a second tong configured to grip a second tubular, wherein rotating the first tubular with respect to the second tubular establishes a connection between the first and second tubulars, wherein a high-contrast material is applied on the connection; and
a strain detection tool configured to detect a strain in the connection by analyzing a change in pattern of the high-contrast material as the first tubular is rotated, wherein the strain detection tool does not contact the connection, and wherein the strain is used to determine an integrity of the connection.

11. The system of claim 10, wherein the pattern of the high-contrast material changes due to deformation of an outer surface of the connection.

12. The system of claim 10, wherein the strain detection tool comprises one or more cameras.

13. The system of claim 12, wherein the one or more cameras are configured to rotate together with the first tubular.

14. The system of claim 12, wherein the one or more cameras comprise a plurality of cameras that are circumferentially-offset from one another around the first tubular, the second tubular, or the connection.

15. The system of claim 12, wherein the one or more cameras comprise a first camera and a second camera, the first and second cameras being circumferentially-offset from one another and configured to view a same area of the first tubular, the second tubular, or the connection.

16. The system of claim 15, wherein the plurality of cameras further comprise a third camera and a fourth camera, the third and fourth cameras being circumferentially-offset from one another and configured to view a same area of the first tubular, the second tubular, or the connection, and wherein an angle between the first and second cameras is less than an angle between the second and third cameras and an angle between the second and fourth cameras.

17. A method for determining an integrity of a first tubular, a second tubular, or a connection therebetween, comprising:
applying a high-contrast material to a first tubular, a second tubular, or a connection therebetween;
varying an axial load on the first tubular, the second tubular, or the connection;
analyzing a change in pattern of the high-contrast material, as the axial load is varied, using a strain detection tool, wherein the strain detection tool does not contact the first tubular, second tubular, or the connection;
detecting a strain at the first tubular, the second tubular, or the connection, based at least partially upon analyzing the change in pattern of the high-contrast material; and
determining an integrity of the first tubular, the second tubular, or the connection, based at least partially upon the strain.

18. The method of claim 17, wherein the axial load is varied by lifting a string of tubulars including the first tubular, the second tubular, and the connection.

19. The method of claim 17, further comprising determining the integrity of the first tubular, the second tubular, or the connection by comparing the strain to a reference strain measurement.

20. The method of claim 17, wherein the pattern of the high-contrast material changes due to deformation of an outer surface of the first tubular, the second tubular, or the connection.

21. The method of claim 20, further comprising determining a stress on the first tubular, the second tubular, or the connection based upon the deformation of the first tubular, the second tubular, or the connection, wherein the integrity of the first tubular, the second tubular, or the connection is determined based upon the strain, the stress, or both.

22. The method of claim 17, wherein the strain detection tool comprises one or more cameras.

23. The method of claim 22, wherein the strain detection tool comprises a plurality of cameras that are circumferentially-offset from one another around the first tubular, and wherein the plurality of cameras are configured to view a same circumferential area of the first tubular.

24. A system for determining an integrity of a first tubular, a second tubular, or a connection therebetween, comprising:
an elevator configured to lift a string of tubulars, including a first tubular, a second tubular, and a connection therebetween, wherein a high-contrast material is applied to the first tubular, the second tubular, the connection, or a combination thereof; and
a strain detection tool configured to detect a strain in the first tubular, the second tubular, or the connection, by analyzing a change in pattern of the high-contrast material as an axial load is varied by the elevator lifting the string of tubulars, wherein the strain detection tool does not contact the connection, and wherein the strain is used to determine an integrity of the first tubular, the second tubular, or the connection.

25. The system of claim 24, wherein the pattern of the high-contrast material changes due to deformation of an outer surface of the first tubular, the second tubular, or the connection.

26. The system of claim 24, wherein the strain detection tool comprises one or more cameras.

27. The system of claim 26, wherein the one or more cameras comprise a plurality of cameras that are circumferentially-offset from one another around the first tubular, the second tubular, or the connection.

28. The system of claim 26, wherein the one or more cameras comprise a first camera and a second camera, the first and second cameras being circumferentially-offset from one another and configured to view a same area of the first tubular, the second tubular, or the connection.

29. The system of claim 28, wherein the plurality of cameras further comprise a third camera and a fourth camera, the third and fourth cameras being circumferentially-offset from one another and configured to view a same area of the first tubular, the second tubular, or the connection, and wherein an angle between the first and second cameras is less than an angle between the second and third cameras and an angle between the second and fourth cameras.

30. A method for determining an integrity of a connection, comprising:
introducing an input signal to a connection between a first tubular and a second tubular;
applying a torque to the first tubular by rotating the first tubular;
receiving an output signal from the connection, wherein the rotation of the first tubular causes the input signal to be modified to produce the output signal;
comparing the input signal to the output signal; and
determining an integrity of the connection, in response to the rotation, based at least partially upon the comparison of the input signal to the output signal.

31. The method of claim 30, further comprising determining the integrity of the connection by comparing the first input signal, the first output signal, or both to a reference signal.

32. The method of claim 31, further comprising automatically stopping rotation of the first tubular when a makeup requirement has been achieved.

33. The method of claim 31, further comprising automatically stopping rotation of the first tubular when the integrity of the connection is less than a predetermined threshold.

34. The method of claim 33, wherein the integrity of the connection is less than the predetermined threshold due to threads of the first and second tubulars being misaligned or damaged, the connection not shouldering, or seals not properly engaging.

35. The method of claim 30, wherein a signal generator introduces the first input signal, and wherein a signal receiver receives the first output signal.

36. The method of claim 35, wherein the signal generator and the signal receiver are both in contact with the connection.

37. The method of claim 35, wherein the signal generator is in contact with the connection, and the signal receiver is not in contact with the connection.

38. The method of claim 35, wherein the signal generator is not in contact with the connection, and the signal receiver is in contact with the connection.

39. The method of claim 35, wherein neither the signal generator nor the signal receiver are in contact with the connection.

40. A system for determining an integrity of a connection, comprising:
a first tong configured to grip and rotate a first tubular;
a second tong configured to grip a second tubular;
a signal generator configured to introduce an input signal into a connection between the first and second tubulars; and
a signal receiver configured to receive an output signal from the connection, wherein the rotation of the first tubular causes the input signal to be modified to produce the output signal.

41. The system of claim 40, wherein an integrity of the connection is determined based at least partially upon a comparison of the input signal to the output signal.

42. The system of claim 40, wherein the signal generator and the signal receiver are both in contact with the connection.

43. The system of claim 40, wherein the signal generator is in contact with the connection, and the signal receiver is not in contact with the connection.

44. The system of claim 40, wherein the signal generator is not in contact with the connection, and the signal receiver is in contact with the connection.

45. The system of claim 40, wherein neither the signal generator nor the signal receiver are in contact with the connection.

46. A method for determining an integrity of a first tubular, a second tubular, or a connection therebetween, comprising:
introducing an input signal into a first tubular, a second tubular, or a connection therebetween, using a signal generator;
varying an axial load on the first tubular, the second tubular, or the connection;
receiving an output signal from the first tubular, the second tubular, or the connection using a signal receiver, while the axial load is varied, wherein varying the axial load causes the input signal to be modified to produce the output signal;
comparing the input signal to the output signal using a signal processor; and
determining an integrity of the first tubular, the second tubular, or the connection, in response to varying the axial load, based at least partially upon the comparison of the input signal to the output signal.

47. The method of claim 46, further comprising determining the integrity of the connection by comparing the input signal, the output signal, or both to a reference signal.

48. The method of claim 46, wherein the signal generator and the signal receiver are both in contact with the connection.

49. The method of claim 46, wherein the signal generator is in contact with the connection, and the signal receiver is not in contact with the connection.

50. The method of claim 46, wherein the signal generator is not in contact with the connection, and the signal receiver is in contact with the connection.

51. The method of claim 46, wherein neither the signal generator nor the signal receiver are in contact with the connection.

52. A system for determining an integrity of a first tubular, a second tubular, or a connection therebetween, comprising:
an elevator configured to lift a string of tubulars, including a first tubular, a second tubular, and a connection therebetween,
a signal generator configured to introduce an input signal into the first tubular, the second tubular, or the connection; and
a signal receiver configured to receive an output signal from the first tubular, the second tubular, or the connection, wherein a change in an axial load experienced at the first tubular, the second tubular, or the connection causes the input signal to be modified to produce the output signal.

53. The system of claim 52, wherein an integrity of the first tubular, the second tubular, or the connection is determined based at least partially upon a comparison of the input signal to the output signal.

54. The system of claim 52, wherein the signal generator and the signal receiver are both in contact with the connection.

55. The system of claim 52, wherein the signal generator is in contact with the connection, and the signal receiver is not in contact with the connection.

56. The system of claim 52, wherein the signal generator is not in contact with the connection, and the signal receiver is in contact with the connection.

57. The system of claim 52, wherein neither the signal generator nor the signal receiver are in contact with the connection.
